(19) United States
(12) Patent Application Publication
(10) Pub. No.: US 2003/0074110 A1
(43) Pub. Date: Apr. 17, 2003

(54) System and method for user control of electrical utility demand - side management

(76) Inventors: Lawrence Silverman, Newton Square, PA (US); Lawrence A. Husick, Malvern, PA (US)

Correspondence Address: Robert S. Lipton, Esquire, LIPTON, WEINBERGER & HUSICK, 201 North Jackson Street, P.O. Box 934, Media, PA, 19063-0934, US

(21) Appl. No.: 10/251,609

(22) Filed: Sep. 20, 2002

Related U.S. Application Data
(63) Continuation of application No. 09/708,236, filed on Nov. 8, 2000, now abandoned.

(51) Int. Cl. G05D 11/00

(52) U.S. Cl. 700/295; 705/412

(57) ABSTRACT

A system and method for permitting an electrical utility's customers (electric energy consumers) to control peak and off-peak use of electricity by providing rate information, billing information, and time/rate control capabilities in a compact user terminal.

### CROSS-REFERENCE TO RELATED APPLICATION

This is a continuation application of U.S. application Ser. No. 09/708,236 filed Nov. 8, 200, which claims the benefit of U.S. application Ser. No. 08/906,123 filed Aug. 5, 1997, which claims the benefit of U.S. Provisional Application No. 60/022,462, filed Aug. 7, 1996.

### BACKGROUND OF THE INVENTION

The present invention relates generally to a system and method for permitting an electrical utility's customers (electric energy consumers) to control peak and off-peak use of electricity by providing rate information, billing information, and time/rate control capabilities in a compact user terminal located in the consumer's home or office.

### SUMMARY OF THE INVENTION

The present invention comprises an electrical utility head-end system for transmitting rate and billing information to a consumer terminal system, and a consumer terminal and controllers for electrical loads including heating, ventilating, and air conditioning systems, electric water heaters, pool pump systems, and the like. Consumer information is presented on a screen, and input is taken by key actuations of the consumer.

### BRIEF DESCRIPTION OF THE DRAWINGS

The accompanying drawings, which are incorporated in and form a part of the specification, illustrate the embodiments of the present invention and, together with the description, serve to explain the principles of the invention.

In the drawings:

FIG. 1 is a representation of the various screens that are displayed on the terminal; and

FIGS. 2 and 3 are a representation of the various screens displayed on the terminal for a Spanish-speaking user.

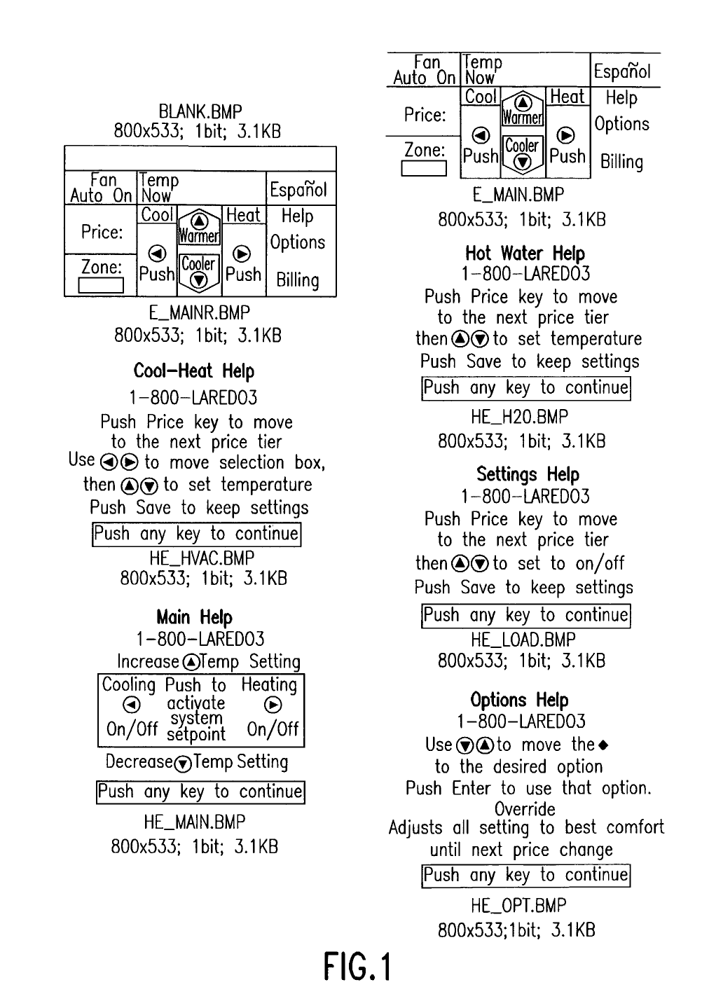

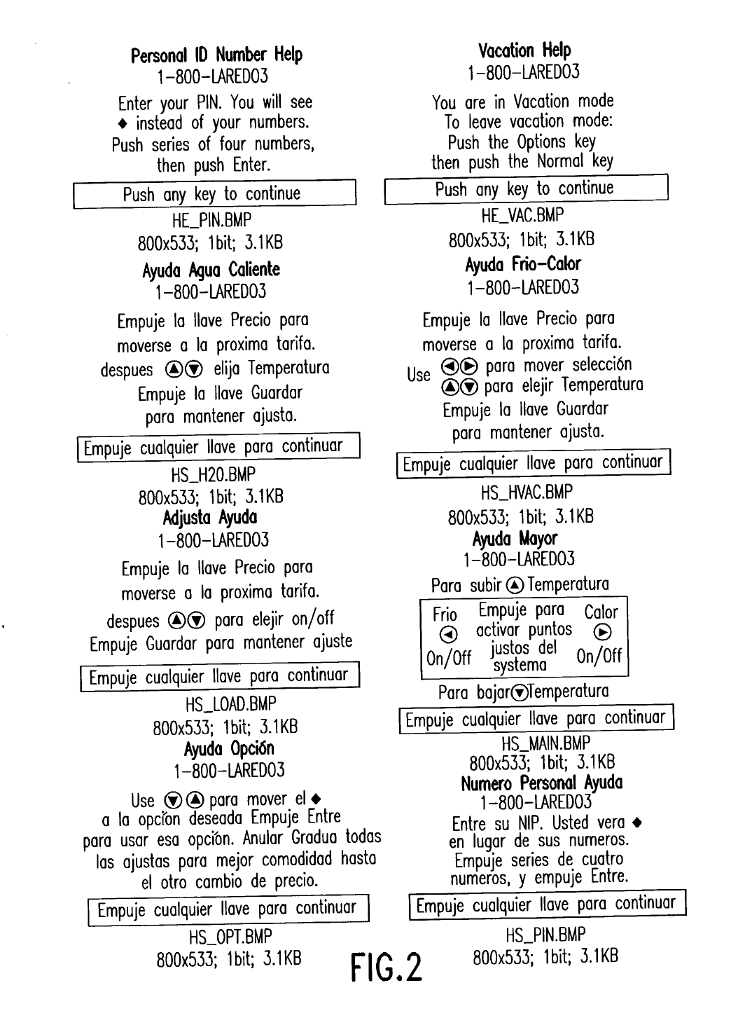

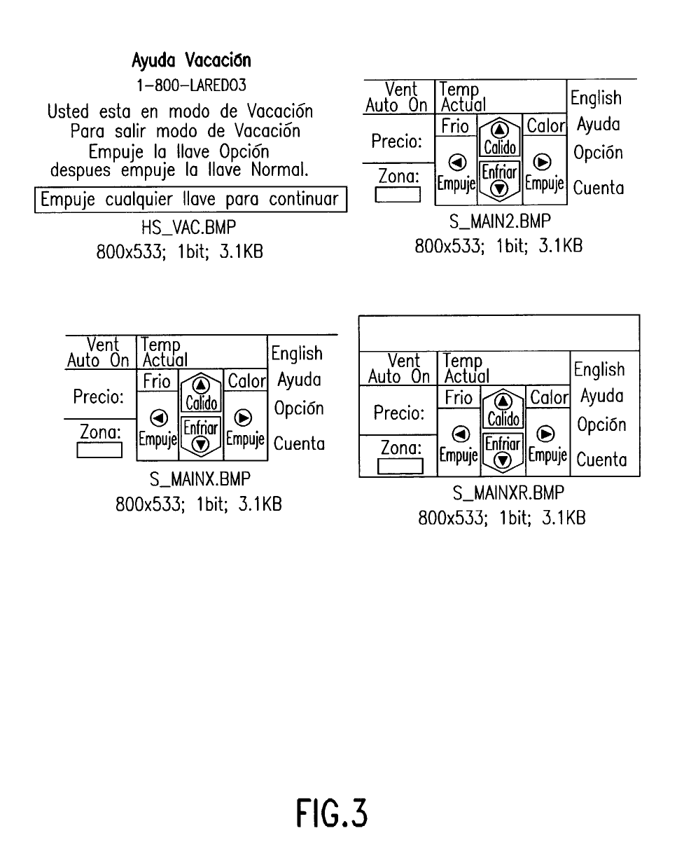

### DETAILED DESCRIPTION OF THE PREFERRED EMBODIMENT

The present invention is a method for controlling energy-consuming loads having associated switching devices capable of controlling their associated loads responsive to received signals uniquely identifying said switching devices. The present invention includes:

a. displaying the identity of one or more loads having said associated switching devices to a user;

b. soliciting from said user a desired load behavior during each of a plurality of energy rate periods;

c. storing said user-desired load behaviors in a digital memory;

d. transmitting signals representative of said user-desired load behaviors from said digital memory to said switching devices associated with said loads;

e. controlling said loads in accordance with said transmitted signals.

The appended computer programs and data files are a complete description of the preferred embodiment of the present invention, and are documented internally to provide one skilled in the art with all information necessary to make the use of invention.

What is claimed is:

1. A method for controlling energy-consuming loads having associated switching devices capable of controlling their associated loads responsive to received signals uniquely identifying said switching devices comprising the steps of:
a. displaying the identity of one or more loads having said associated switching devices to a user;
d. soliciting from said user a desired load behavior during each of a plurality of energy rate periods;
e. storing said user-desired load behaviors in a digital memory;
d. transmitting signals representative of said user-desired load behaviors from said digital memory to said switching devices associated with said loads;
e. controlling said loads in accordance with said transmitted signals.
